(19) United States
(12) Patent Application Publication
(10) Pub. No.: US 2020/0141155 A1
(43) Pub. Date: May 7, 2020

(54) FLEXIBLE COUPLING FOR ELECTRONIC DEADBOLT SYSTEMS

(71) Applicant: Amesbury Group, Inc., Amesbury, MA (US)

(72) Inventors: Tracy Lammers, Sioux Falls, SD (US); Douglas John Criddle, Sioux Falls, SD (US)

(21) Appl. No.: 16/664,144

(22) Filed: Oct. 25, 2019

Related U.S. Application Data
(60) Provisional application No. 62/756,356, filed on Nov. 6, 2018.

(51) Int. Cl. E05B 47/00

(52) U.S. Cl. CPC E05B 47/0001; E05B 2047/0031; E05B 2047/002

(57) ABSTRACT

An electronic deadbolt includes a housing, a deadbolt configured to extend or retract from the housing, and a drive system disposed at least partially within the housing. The drive system includes an electric motor and a leadscrew coupled between the electric motor and the deadbolt. The leadscrew is rotatable about a longitudinal axis so as to dive movement of the deadbolt. The drive system also includes a flexible coupling disposed between the electric motor and the leadscrew and is configured to absorb torsional loads generated by the movement of the deadbolt.

### CROSS-REFERENCE TO RELATED APPLICATIONS

This application claims priority to and the benefit of U.S. Provisional Patent Application No. 62/756,356, filed Nov. 6, 2018, the disclosure of which is hereby incorporated by reference herein in its entirety.

### INTRODUCTION

Deadbolts are typically operated by a user (e.g., with a key on an outside of the door or a thumbturn on the inside of the door) to secure a door or a window against unwanted intrusions. At least some known deadbolts are motorized, but it can often be difficult to install these systems within doors, as well as deliver reliable power. Additionally, during operation of at least some motorized deadbolts, the drive systems may undesirably experience increased loading at the end of the stroke length of the deadbolt.

### SUMMARY

In an aspect, the technology relates to an electronic deadbolt including: a housing; a deadbolt configured to extend or retract from the housing; and a drive system disposed at least partially within the housing, wherein the drive system includes: an electric motor; a leadscrew coupled between the electric motor and the deadbolt, wherein the leadscrew is rotatable about a longitudinal axis so as to dive movement of the deadbolt; and a flexible coupling disposed between the electric motor and the leadscrew.

In an example, the flexible coupling includes: a drive hub including at least one drive lug; a driven hub including at least one driven lug; and a flexible collar disposed at least partially between the at least one drive lug and the at least one driven lug. In another example, the at least one drive lug and the at least one driven lug extend radially relative to the longitudinal axis. In still another example, the leadscrew has a first end and an opposite second end, and the first end is threadingly coupled to the deadbolt and the second end includes the driven hub. In yet another example, the driven hub is integral with the second end of the leadscrew. In an example, the driven hub includes a bore sized and shaped to at least partially receive the drive hub and the flexible collar.

In another example, the drive hub includes a pair of drive lugs of the at least one drive lug spaced approximately 180° apart and the driven hub includes a pair of driven lugs of the at least one driven lug spaced approximately 180° apart. In still another example, the flexible collar includes four legs, each disposed between a drive lug of the pair of drive lugs and a driven lug of the pair of driven lugs. In yet another example, the housing defines the longitudinal axis. In an example, the flexible coupling is configured to absorb torsional loads generated by the movement of the deadbolt.

In another aspect, the technology relates to a drive system for an electronic lock device including a locking element and a housing, wherein the drive system includes: an electric motor; a rotatable shaft coupled to the electric motor and rotatable about a longitudinal axis; a drive hub coupled to the rotatable shaft; a driven hub rotationally engaged with the drive hub; a leadscrew coupled to the driven hub, wherein upon rotation of the leadscrew the locking element extends or retracts from the housing; and a flexible collar disposed at least partially between the drive hub and the driven hub, wherein the flexible collar is configured to absorb torsional loads between the drive hub and the driven hub.

In an example, the electric motor includes at least one gear. In another example, the drive hub is at least partially received within the driven hub. In still another example, the driven hub is integral with the leadscrew. In yet another example, the drive hub includes a plurality of drive lugs and the driven hub includes a plurality of driven lugs, the flexible collar includes a plurality of legs and each leg is disposed between one drive lug of the plurality of drive lugs and one driven lug of the plurality of driven lugs. In an example, each leg is in direct contact with the drive lug and the driven lug.

In another example, the plurality of legs are connected to one another. In still another example, the electric motor, the rotatable shaft, and the leadscrew are axially aligned along the longitudinal axis.

In another aspect, the technology relates to an electronic lock device for a door or a window including: a housing; a locking element; and a drive system disposed at least partially within the housing and configured to extend or retract the locking element from the housing, wherein the drive system includes: an electric motor including one or more gears driving a rotatable shaft about a longitudinal axis; a leadscrew coupled between the electric motor and the locking element, wherein the leadscrew is rotatable about the longitudinal axis so as to dive movement of the locking element; and a flexible coupling disposed between the electric motor and the leadscrew, wherein the flexible coupling includes: a drive hub including a pair of drive lugs coupled to the rotatable shaft; a driven hub including a pair of driven lugs coupled to the leadscrew; and a flexible collar disposed at least partially between the drive hub and the driven hub.

In an example, the flexible coupling is axially aligned with the leadscrew and the electric motor along the longitudinal axis.

### BRIEF DESCRIPTION OF THE DRAWINGS

There are shown in the drawings, examples that are presently preferred, it being understood, however, that the technology is not limited to the precise arrangements and instrumentalities shown.

FIG. 1 depicts a schematic view of an electronic door lock system.

FIG. 2 is a perspective view of an exemplary electronic lock device.

FIG. 3 is a perspective view of an exemplary drive system.

FIG. 4 is an exploded perspective view of the drive system shown in FIG. 3.

FIG. 5 is an exploded side view of an exemplary flexible coupling.

FIG. 6 is a partial end view of the flexible coupling shown in FIG. 5.

### DETAILED DESCRIPTION

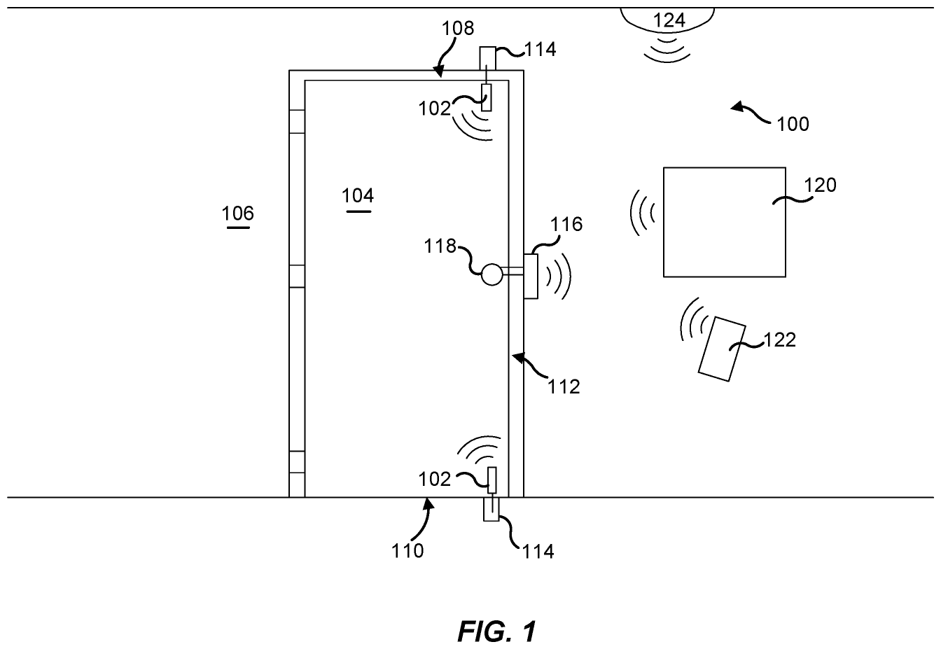

FIG. 1 depicts a schematic view of one example of a multi-point electric door lock system 100. The system 100 includes two electronic deadbolts 102 installed in a door panel 104, for example, so as to extend into a portion of a frame 106 such as a head and/or a sill thereof. In other examples, the electronic deadbolts 102 may be installed within a locking edge of the door panel 104 so as to extend into a vertical portion of the frame 106 between the head and the sill. Alternatively, the electronic deadbolts 102 may be installed in the frame 106 so as to extend into the door 104. Additionally, the placement and number of electronic deadbolts 102 may be altered as required or desired for a particular application, for example, in pivoting doors, the electronic deadbolts may be disposed so as to extend from a head 108, a sill 110, or a locking edge 112 (e.g., vertical edge) of the door 104.

In the example, the door panel 104 is a pivoting door; however, the electronic deadbolts described herein can be utilized in entry doors, sliding doors, pivoting patio doors, and any other door as required or desired. In sliding patio doors, the electronic deadbolts 102 have linearly extending locking elements that may extend from the head 108 or the sill 110 of the sliding door. If utilized on the locking edge 112 of a sliding door, the electronic deadbolt 102 would require a hook-shaped locking element that would hook about a keeper so as to prevent retraction of the door. Additionally or alternatively, the electronic deadbolts may be used in windows or any other panel type structure that can be locked with an extendable and/or retractable locking element.

In the example, each electronic deadbolt 102 is positioned to as to extend into a keeper 114. The keepers 114 may be standard keepers or electronic keepers as described in U.S. patent application Ser. No. 15/239,714, filed Aug. 17, 2016, entitled “Locking System Having an Electronic Keeper,” and the disclosure of which is herein incorporated by reference in its entirety. The system 100 also includes an electronic keeper 116 configured to receive a standard (e.g., manually-actuated) deadbolt 118, as typically available on an entry or patio door.

In one example, once the deadbolt 118 is manually actuated into the locking position, the electronic keeper 116 detects a position of the deadbolt 118 therein. A signal may be sent to the remotely located electronic deadbolts 102, thus causing actuation thereof. At this point, the door 104 is now locked at multiple points. Unlocking of the manual deadbolt 118 is detected by the electronic keeper 116 (that is, the keeper 116 no longer detects the presence of the deadbolt 118 therein) and a signal is sent to the remote electronic deadbolts 102 causing retraction thereof, thus allowing the door 104 to be opened. Thus, the electronic deadbolts described herein may be utilized to create a robust multi-point locking system for a door and to improve the security thereof.

In another example, the system 100 may include a controller/monitoring system, which may be a remote panel 120, which may be used to extend or retract the electronic deadbolts 102, or which may be used for communication between the various electronic keepers 114 and deadbolts 102. Alternatively or additionally, an application on a remote computer or smartphone 122 may take the place of, or supplement, the remote panel 120. By utilizing a remote panel 120 and/or a smartphone 122, the electronic deadbolts 102 may be locked or unlocked remotely, thus providing multi-point locking ability without the requirement for manual actuation of the deadbolt 118. Additionally, any or all of the components (electronic deadbolt 102, keeper 116, panel 120, and smartphone 122) may communicate either directly or indirectly with a home monitoring or security system 124. The communication between components may be wireless, as depicted, or may be via wired systems.

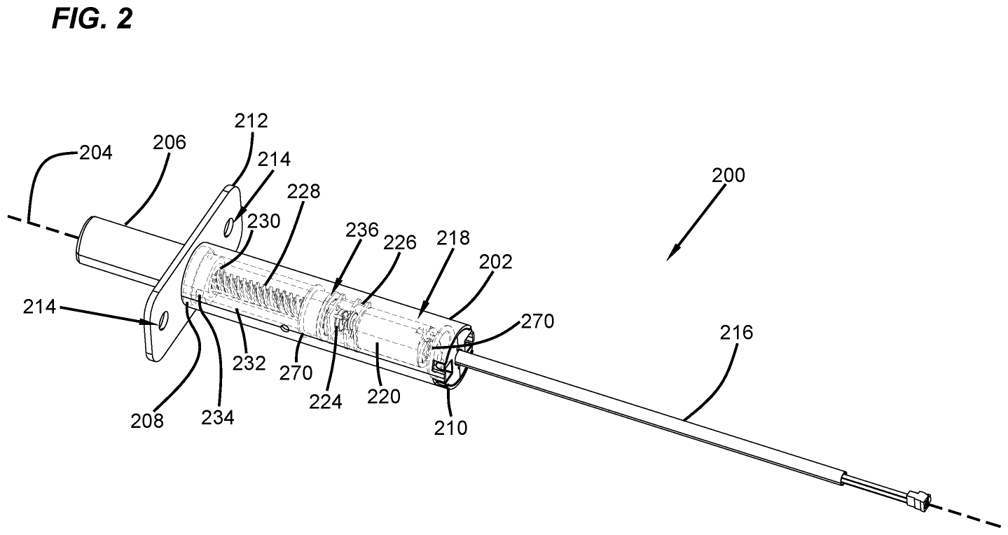

FIG. 2 is a perspective view of an exemplary electronic lock device 200 that can be used with the multi-point electric door lock system 100 (shown in FIG. 1). The electronic lock device 200 is configured to be mounted on a door or door frame and provide a lock thereto. The electronic lock device 200 includes a housing 202 defining a longitudinal axis 204, and a locking element 206 configured to be extended and retracted from the housing 202. As illustrated in FIG. 2, the housing 202 is illustrated as transparent so as to show the components contained therein (e.g., depicted in dashed lines). In the example, the electronic lock device has a locking element that is a deadbolt 206 so that the device can be considered an electronic deadbolt 200. It is appreciated that while a deadbolt locking device is shown and described herein, the locking element can be of any other type, for example, a rhino hook, a shoot bolt, etc. as required or desired.

In the example, the deadbolt 206 is linearly moveable in relation to the housing 202 along the longitudinal axis 204. The housing 202 includes a first end 208 and an opposite second end 210 extending along the longitudinal axis 204. The deadbolt 206 is disposed at the first end 208 so that it may extend and retract along the longitudinal axis 204. A mounting plate 212 with apertures 214 may be coupled to the first end 208 to facilitate mounting the electronic deadbolt 200 to the door or door frame by one or more fasteners (not shown). Extending from the second end 210, an electrical connecting cable 216 is used to provide power and/or operational communication to the electronic deadbolt 200. In one example, the cable 216 may be coupled to a battery module (not shown) that is also mounted within the door and/or door frame. The battery module may couple to one or more lock devices 200 itself. In another example, the electrical cable 216 may be coupled to line power of the structure that the door and/or door frame is within. The housing 202 encloses a deadbolt drive system 218 that is disposed between the first end 208 and the second end 210 and coupled to the cable 216. As illustrated, the deadbolt 206 is a linearly extending locking member. In other examples, the deadbolt 206 may include hook-shaped locking members that rotate out of the housing 202 and enable sliding doors to be locked from the locking edge of the door.

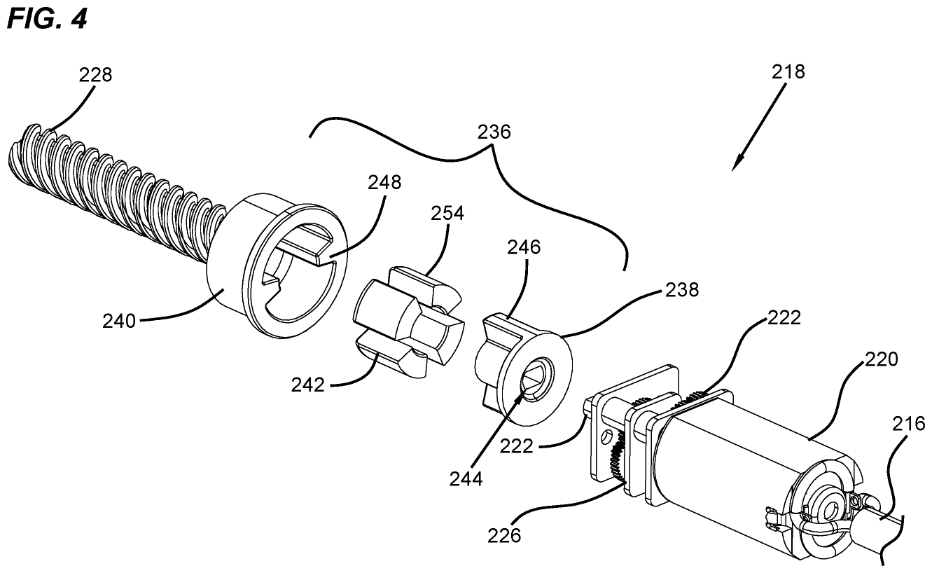

The drive system 218 is disposed at least partially within the housing 202 and is configured to extend and retract the deadbolt 206 from the housing 202. The drive system 218 includes an electric motor 220 that is configured to rotatably drive a rotatable shaft 222 (shown in FIG. 4). The rotatable shaft 222 extends along the longitudinal axis 204 and rotates about the axis 204. The motor 220 may be an off-the-shelf DC unit that includes an integral gear set 224 surrounded by a chassis 226 and powered via the cable 216. The rotatable shaft of the motor 220 is coupled to a leadscrew 228 such that upon operation of the motor 220, the leadscrew 228 rotates about the longitudinal axis 204. The leadscrew 228 extends along the longitudinal axis 204 and is coupled to the deadbolt 206. In the example, the deadbolt 206 includes a nut 230 that threadably engages with the leadscrew 228, such that rotation of the leadscrew 228 translates into linear movement of the nut 230, and thereby, the deadbolt 206 along the longitudinal axis 204.

In the example, the deadbolt 206 or the nut 230 engages with one or more fixed guide channels 232 defined within the housing 202 and extending along the longitudinal axis 204 adjacent to the leadscrew 228. For example, the deadbolt 206 can have one or more projections 234 that are slidably received at least partially within a corresponding guide channel 232. The engagement between the projections 234 and the guide channels 232 prevent rotation of the nut 230, but allow longitudinal movement, so that upon rotation of the leadscrew 228, the deadbolt 206 can extend and retract from the housing 202. In one example, the electronic deadbolt 200 may be a portion of the electronic deadbolt systems that are described in U.S. patent application Ser. No. 15/954,940, filed Apr. 17, 2018, entitled “Modular Electronic Deadbolt Systems,” and the disclosure of which is herein incorporated by reference in its entirety.

The longitudinal length of the guide channels 232 within the housing 202 may define the extension distance of the deadbolt 206 from the housing 202. As such, the ends of the guide channels 232 form a hard stop for the deadbolt 206. In other examples, other components of the lock device 200 may define the hard stop for the deadbolt 206. For example, the first end 208 of the housing 202 may form a hard stop for the deadbolt 206. These hard stops define the stroke length of the deadbolt 206 (e.g., the extension/retraction length along the longitudinal axis 204). That is, when the motor 220 is extending the deadbolt 206 from the housing 202, the motor 220 rotates in a first direction until the hard stop proximate the first end 208 contacts the deadbolt 206, thus preventing any further extension therefrom. The motor 220, however, still operates and drives against the hard stop until the system stops the extension operation. Similarly, when the motor 220 is retracting the deadbolt 206 into the housing 202, the motor 220 rotates in an opposite second direction until the hard stop proximate the second end 210 contacts the deadbolt 206, preventing any further retraction therein. The shock loads that are introduced into the drive system 218 from the hard stops (e.g., the motor 220 driving the deadbolt 206 into the hard stop and the continued motor drive until the system stops the extension/retraction operation) can undesirably reduce the life cycle of the drive system 218. More specifically, undesirable wear is introduced into one or more components of the drive system 218 from the hard stops and motor drive. For example, the teeth of the gear set 224 may crack and/or break due to these loads.

Accordingly, to at least partially absorb the loads generated by the hard stops and the motor drive, a flexible coupling 236 may be disposed between the motor 220 and the leadscrew 228. The flexible coupling 236 is configured to absorb torsional loads generated by the movement of the deadbolt 206 and allows these loads to be absorbed before reaching the gear set 224 and the motor 220, thereby increasing the life span of the drive system 218. Additionally, unlike stroke limit switches or stepper motor type drives, when the deadbolt 206 is between the hard stops and becomes bound (e.g., unable to axially move relative to the housing 202), the flexible coupling 236 also absorbs these loads to reduce wear on the gear set 224 and the motor 220. In the example, the flexible coupling 236 is axially aligned with the leadscrew 228 and the motor 220 along the longitudinal axis 204.

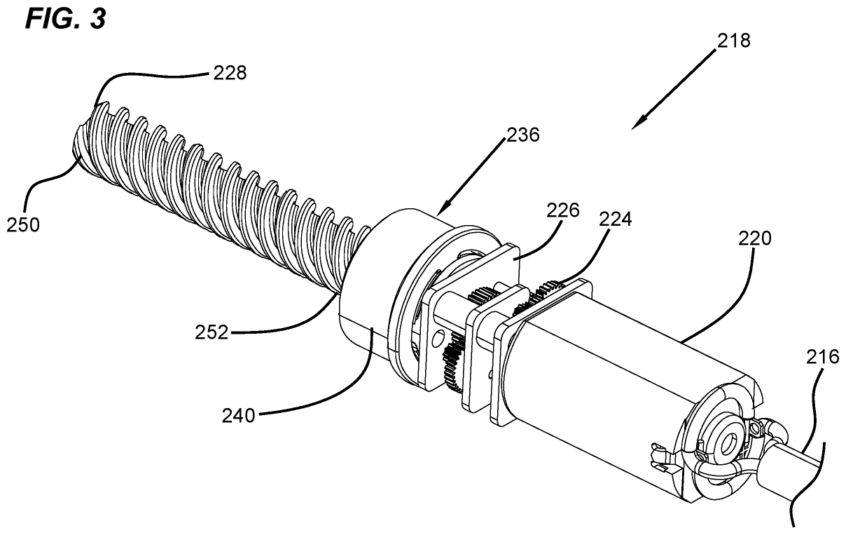

FIG. 3 is a perspective view of the drive system 218. FIG. 4 is an exploded perspective view of the drive system 218. Referring concurrently to FIGS. 3 and 4, the drive system 218 includes the electric motor 220 (e.g., a DC motor) connected to the cable 216. The motor 220 includes the gear set 224 surrounded by the chassis 226, and has the rotatable shaft 222 extending therefrom. In the example, the shaft 222 may have a double D shape, although other shapes are also contemplated herein. To couple the leadscrew 228 to the shaft 222, the flexible coupling 236 is used. The flexible coupling 236 is configured to absorb loads induced into the drive system 218 (e.g., by the hard stops of the deadbolt), thereby, increasing the life cycle of the motor 220 and gear set 224.

In the example, the flexible coupling 236 includes a drive hub 238 that is coupled to the shaft 222 so that the motor 220 can drive rotation of the hub 238. A driven hub 240 is coupled to the leadscrew 228 and is configured to rotationally engage with the drive hub 238. The flexible coupling 236 also includes a flexible collar 242 disposed at least partially between the drive hub 238 and the driven hub 240. The drive hub 238 includes an opening 244 that is sized and shaped to receive the shaft 222 so that the drive hub 238 is coupled to the shaft 222 via a slide on connection. The drive hub 238 also includes at least one drive lug 246 radially extending in an outward direction from the longitudinal axis 204 (shown in FIG. 2). In the example, the drive hub 238 includes two drive lugs that are spaced approximately 180° apart from one another.

The driven hub 240 includes at least one driven lug 248 radially extending in an inward direction from the longitudinal axis. In the example, the driven hub 240 includes two driven lugs that are spaced approximately 180° apart from one another. The leadscrew 228 has a first end 250 that is configured to threadingly couple to the deadbolt and an opposite second end 252 that couples to the driven hub 240. In one example, the driven hub 240 can be integral with the second end 252 of the leadscrew 228.

The drive hub 238 is configured to couple to the driven hub 240 so that upon rotation of the shaft 222, the drive lugs 246 engage with the driven lugs 248, and rotation of the shaft 222 is transferred to the leadscrew 228. In the example, the lug pairs 146, 148 do not completely fill the circumferential space around the longitudinal axis and as such, rotation of the drive hub 238 does not necessary induce direct rotation of the driven hub 240. That is, until the lugs 246, 248 are engaged with one another. In other examples, the number of lugs on each hub may be more (e.g., 3, 4, 5, etc.) or less (e.g., 1) as required or desired. In the example, the lugs 246, 248 on each hub are symmetrically spaced about the longitudinal axis. In other examples, the lugs 246, 248 on each hub may have different circumferential spacing such that the rotational distance until the lugs are engaged is different for forward rotation operation than for backward rotation operation.

In the example, the drive hub 238 is at least partially received within the driven hub 240. The driven hub 240 has an outer diameter that is greater than an outer diameter of the leadscrew 228. As such, the driven hub 240 is enlarged relative to the leadscrew. The enlarged driven hub 240 defines an open bore that is sized and shaped to at least partially receive the drive hub 238 and the flexible collar 242. By inserting the drive hub 238 within the driven hub 240 the axial length of the flexible coupling 236 is reduced so as to conserve space within the electronic lock device. In other examples, the drive hub 238 may be enlarged so as to receive the driven hub 240 therein.

The flexible collar 242 of the flexible coupling 236 is disposed at least partially between the drive lugs 246 and the driven lugs 248 and is configured to absorb torsional loads from transferring between the drive hub 238 and the driven hub 240. In the example, the flexible collar 242 includes four legs 254 that are each disposed between one drive lug 246 and one driven lug 248. This configuration enables for the drive hub 238 to be insertable within the driven hub 240 and reduces the axial length of the flexible coupling 236 within the drive system 218. In some examples, one or more of the four legs 254 may be connected to one another (e.g., along an inner circumferential surface, an outer circumferential surface, or an axial surface). In other examples, one or more of the four legs 254 may be discrete from one another.

In the example, each leg 254 of the flexible collar 242 circumferentially extends within the entire space between the drive lug 246 and the driven lug 248. That is, each leg 254 is in direct contact with both the adjacent drive lug 246 and the adjacent driven lug 248. As such, the flexible collar 242 is always engaged upon rotation of the hubs 238, 240 relative to one another. In other examples, the legs 254 are only partially disposed within the space between the drive lug 246 and the driven lug 248 so that the hubs 238, 240 may rotate relative to one another before the flexible collar 242 is engaged.

The flexible collar 242 may be a silicone-based material (e.g., a Shore A20 hardness), a neoprene-based material (e.g., a Shore A30 hardness), or any other material that enables to flexible coupling 236 to function as described herein. These materials enable the shock and torsion loads from the deadbolt travel to be absorbed, for example, through compression of the flexible collar 242, so that the loads do not travel from the leadscrew 228, through the drive system 218, and into the motor 220 and the gear set 224. Additionally, the materials are tear and impact resistant so that they can withstand a large number of extension and retraction cycles of the locking member.

Additionally, the flexible coupling 236 also reduces wear on the motor 220 and gear set 224 if the drive system 218 binds up during operation and between the hard stops that define the stroke length of the deadbolt. For example, if the deadbolt is extended against a strike plate so that the deadbolt cannot fully extend, the flexible coupling 236 reduces or prevents the resulting load from being transferred back to the motor 220 and gear set 224. In contrast, other systems, such as end of stroke limit switches or stepper motor type drives that can limit the hard stop loads, cannot do this, as it is only the hard stop areas that are load resistant.

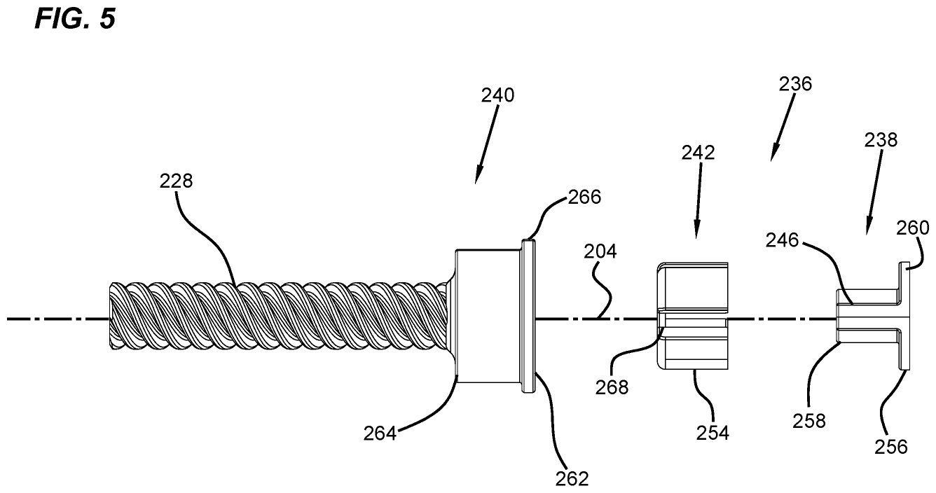

FIG. 5 is an exploded side view of the exemplary flexible coupling 236. In the example, the drive hub 238 has a first end 256 and an opposite second end 258 in an axial direction along the longitudinal axis 204. The first end 256 includes the opening 244 (shown in FIG. 5) that extends towards the second end 258 and so that the drive hub 238 can be coupled to the motor and rotatably driven thereby. The first end 256 also includes a radially extending flange 260 that extends outward from the opening 244. The flange 260 is positioned adjacent to the chassis 226 of the drive system 218 (both shown in FIG. 5) when assembled and provides support for the drive lugs 246. Additionally, the flange 260 provides an axial boundary for the flexible collar 242 so that the collar legs 254 are axially retained within the flexible coupling 236 and do not slide out of the flexible coupling when assembled. The drive lugs 246 extend from the second end 258 and towards the flange 260, and in a radially outward direction relative to the longitudinal axis 204.

The driven hub 240 also has a first end 262 and an opposite second end 264 in an axial direction. The driven hub 240 is substantially cylindrical in shape with an open bore at the first end 262 that is sized and shaped to receive the drive hub 238. The bore extends from the first end 262 in a direction towards the second end 264. The bore has an inner diameter that is greater than an outer diameter of the drive hub 238 so that the driven hub 240 can receive the drive hub 238 within. The first end 262 also includes a radially extending circumferential lip 266. The lip 266 is configured to be received within a corresponding circumferential channel with the housing 202 (shown in FIG. 2) so that the driven hub 240 is axially secured within the housing while still being enabled for rotational movement. The second end 264 of the driven hub 248 is enclosed so that the leadscrew 228 can extend therefrom. The driven lugs 248 (shown in FIG. 5) are positioned within the bore and extend from the first end 262 in a direction towards the second end 264 and in a radially inwardly direction.

The flexible collar 242 has legs 254 that extend in an axial direction and along the longitudinal axis 204. Each leg 254 is circumferentially spaced from one another so that the lugs 246, 248 can slide therebetween. In the example, one axial end of all of the legs 254 are coupled together by a connector 268. By connecting all of the legs 254 together, assembly of the flexible coupling 236 is more efficient. Additionally in the example, the connector 268 is positioned adjacent the second end 264 of the driven hub 240 when the flexible coupling 236 is assembled. As such, the connector 268 can be used to absorb axial loads between the two hubs 238, 240 so that the flexible coupling 236 can absorb both torsional and axial loads within the drive system. Opposite of the connector 268, the free ends of the legs 254 are positioned adjacent the flange 260 of the drive hub 238 when the flexible coupling 236 is assembled.

To accommodate the small size of many electronic deadbolts, the flexible coupling 236 has the drive hub 238 and the flexible collar 242 received entirely within the driven hub 240. This reduces the overall axial length of the flexible coupling 236 and can reduce the size of the electronic lock device. Additionally, the outer surface of the driven hub 240 can be used as a bearing surface within the housing so that the leadscrew 228 is supported within the housing. For example, with the lip 266. Additionally or alternatively, an O-ring 270 (shown in FIG. 2) may be located around the second end 264 of the driven hub 240 so as to form a seal within the housing and reduce dirt and debris from accumulating around the motor and/or gears. Another O-ring 270 may also be located at the second end of the housing as required or desired.

In other examples, the flexible coupling 236 may have the drive hub 238 and the driven hub 240 only axially aligned and one is not received within another. As such, the lugs 246, 248 can extend in an axial direction and the collar 242 is axially positioned between the hubs 238, 240. In this configuration, however, the axial length of the flexible coupling 236 is increased, compared to the example as illustrated in FIGS. 3-5.

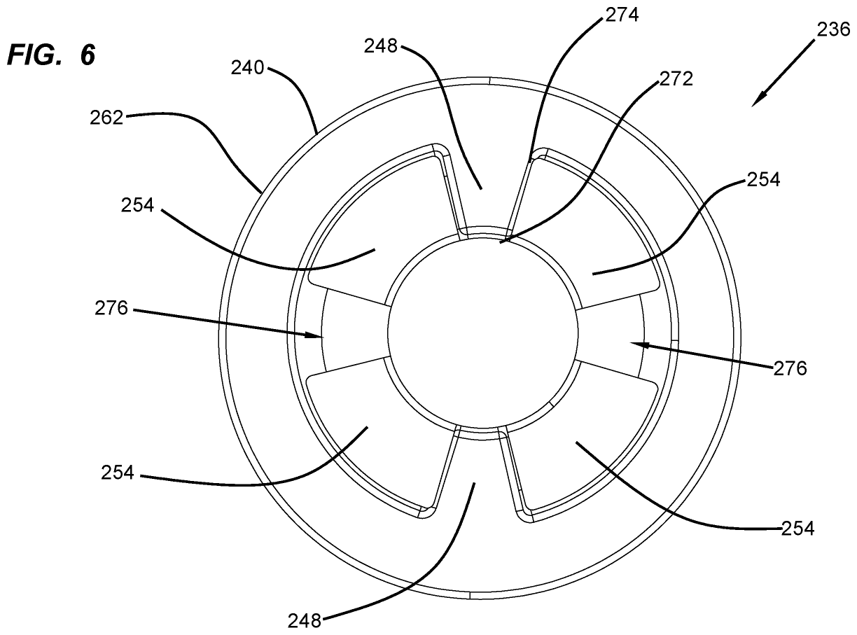

FIG. 6 is a partial end view of the flexible coupling 236. The drive hub 238 is not illustrated in FIG. 6 for clarity. Looking at the first end 262 of the driven hub 240, the driven lugs 248 are directly opposite one another and extend in an inward direction. In the example, the lugs 248 have a tip 272 that is smaller than a base 274 so that in cross-section, the lugs 248 are substantially tooth shaped. So that the flexible collar 242 can be circumferentially fit between the lugs 248, each leg 254 is spaced apart from another and this space 276 has a shape that corresponds to the shape of the lugs 248. As illustrated in FIG. 6, the void within the flexible collar 242 receives the drive hub 238. With the drive hub 238, the lugs 246 have a tip that is larger than a base so that the lugs can fit within the space 276 defined by the flexible collar 242. In an aspect, the size proportion between the lug tip and base is based on its radial position relative to the longitudinal axis. In other examples, the lugs can have any other shape that enables the flexible coupling 236 to function as described herein. For example, the lugs may be partially rounded or have a square or rectangle shape in cross-section.

When the flexible coupling 236 is assembled, each leg 254 of the flexible collar 242 is directly adjacent to the lugs. In one example, the compressive strength of the collar 242 may be such that any rotation of the drive hub 238 enables rotation of the driven hub 240. However, once a predetermined torque load is reached, the compressive strength of the collar 242 is overcome to absorb the excess loads and increase the life-cycle of the drive system. In another example, the compressive strength of the collar 242 may be such that the collar 242 can absorbs some rotational movement between the hubs. However, once the legs 254 are compressed to a predetermined value then rotational movement can be transferred between the hubs, and any further over-compression is used to absorb the excess loads. In either example, to define the absorption capacity of the collar 242, the compressive strength of the material can be specified as required or desired. For example, a lower compressive strength can allow more independent rotational movement between the hubs when compared to a higher compressive strength material. In some examples, the legs 254 may not be positioned directly against the lugs so that there is a gap between the leg and the lug to allow for more independent rotational movement between the hubs.

In the example, each leg 254 may circumferentially extend about 60° about the longitudinal axis. Additionally, each lug 246, 248 may circumferentially extend about 30° about the longitudinal axis. As such, the ratio between lugs and collar within the flexible coupling is about 1:2 and the legs are circumferentially larger than the lugs. In other examples, each leg 254 may circumferentially extend between about 20° and about 80°. In an aspect, each leg 254 may circumferentially extend between about 45° and about 75°. In yet another example, each lug 246, 248 may circumferentially extend between about 10° and 70°. In an aspect, each lug 246, 248 may circumferentially extend between about 15° and 45°. In examples, the legs may be circumferentially smaller than the lugs, or circumferentially equal to the lugs (e.g., a 1:1 ratio), as required or desired.

The materials utilized in the manufacture of the lock and drive components described herein may be those typically utilized for lock manufacture, e.g., zinc, steel, aluminum, brass, stainless steel, etc. Molded plastics, such as PVC, polyethylene, etc., may be utilized for the various components. Material selection for most of the components may be based on the proposed use of the locking system. Appropriate materials may be selected for mounting systems used on particularly heavy panels, as well as on hinges subject to certain environmental conditions (e.g., moisture, corrosive atmospheres, etc.).

As used herein, the terms “axial” and “longitudinal” refer to directions and orientations, which extend substantially parallel to the longitudinal axis of the housing. Moreover, the terms “radial” and “radially” refer to directions and orientations, which extend substantially perpendicular to the longitudinal axis. In addition, as used herein, the terms “circumferential” and “circumferentially” refer to directions and orientations, which extend arcuately about longitudinal axis.

While there have been described herein what are to be considered exemplary and preferred examples of the present technology, other modifications of the technology will become apparent to those skilled in the art from the teachings herein. The particular methods of manufacture and geometries disclosed herein are exemplary in nature and are not to be considered limiting. It is therefore desired to be secured in the appended claims all such modifications as fall within the spirit and scope of the technology. Accordingly, what is desired to be secured by Letters Patent is the technology as defined and differentiated in the following claims, and all equivalents.

What is claimed:

1. An electronic deadbolt comprising:
a housing;
a deadbolt configured to extend or retract from the housing; and
a drive system disposed at least partially within the housing, wherein the drive system comprises:
an electric motor;
a leadscrew coupled between the electric motor and the deadbolt, wherein the leadscrew is rotatable about a longitudinal axis so as to dive movement of the deadbolt; and
a flexible coupling disposed between the electric motor and the leadscrew.

2. The electronic deadbolt of claim 1, wherein the flexible coupling comprises:
a drive hub comprising at least one drive lug;
a driven hub comprising at least one driven lug; and
a flexible collar disposed at least partially between the at least one drive lug and the at least one driven lug.

3. The electronic deadbolt of claim 2, wherein the at least one drive lug and the at least one driven lug extend radially relative to the longitudinal axis.

4. The electronic deadbolt of claim 2, wherein the leadscrew has a first end and an opposite second end, and wherein the first end is threadingly coupled to the deadbolt and the second end comprises the driven hub.

5. The electronic deadbolt of claim 4, wherein the driven hub is integral with the second end of the leadscrew.

6. The electronic deadbolt of claim 2, wherein the driven hub comprises a bore sized and shaped to at least partially receive the drive hub and the flexible collar.

7. The electronic deadbolt of claim 2, wherein the drive hub comprises a pair of drive lugs of the at least one drive lug spaced approximately 180° apart and the driven hub comprises a pair of driven lugs of the at least one driven lug spaced approximately 180° apart.

8. The electronic deadbolt of claim 7, wherein the flexible collar comprises four legs, each disposed between a drive lug of the pair of drive lugs and a driven lug of the pair of driven lugs.

9. The electronic deadbolt of claim 1, wherein the housing defines the longitudinal axis.

10. The electronic deadbolt of claim 1, wherein the flexible coupling is configured to absorb torsional loads generated by the movement of the deadbolt.

11. A drive system for an electronic lock device comprising a locking element and a housing, wherein the drive system comprises:
an electric motor;
a rotatable shaft coupled to the electric motor and rotatable about a longitudinal axis;
a drive hub coupled to the rotatable shaft;
a driven hub rotationally engaged with the drive hub;
a leadscrew coupled to the driven hub, wherein upon rotation of the leadscrew the locking element extends or retracts from the housing; and
a flexible collar disposed at least partially between the drive hub and the driven hub, wherein the flexible collar is configured to absorb torsional loads between the drive hub and the driven hub.

12. The drive system of claim 11, wherein the electric motor comprises at least one gear.

13. The drive system of claim 11, wherein the drive hub is at least partially received within the driven hub.

14. The drive system of claim 11, wherein the driven hub is integral with the leadscrew.

15. The drive system of claim 11, wherein the drive hub comprises a plurality of drive lugs and the driven hub comprises a plurality of driven lugs, wherein the flexible collar includes a plurality of legs and each leg is disposed between one drive lug of the plurality of drive lugs and one driven lug of the plurality of driven lugs.

16. The drive system of claim 13, wherein each leg is in direct contact with the drive lug and the driven lug.

17. The drive system of claim 13, wherein the plurality of legs are connected to one another.

18. The drive system of claim 11, wherein the electric motor, the rotatable shaft, and the leadscrew are axially aligned along the longitudinal axis.

19. An electronic lock device for a door or a window comprising:
a housing;
a locking element; and
a drive system disposed at least partially within the housing and configured to extend or retract the locking element from the housing, wherein the drive system comprises:
an electric motor comprising one or more gears driving a rotatable shaft about a longitudinal axis;
a leadscrew coupled between the electric motor and the locking element, wherein the leadscrew is rotatable about the longitudinal axis so as to dive movement of the locking element; and
a flexible coupling disposed between the electric motor and the leadscrew, wherein the flexible coupling comprises:
a drive hub comprising a pair of drive lugs coupled to the rotatable shaft;
a driven hub comprising a pair of driven lugs coupled to the leadscrew; and
a flexible collar disposed at least partially between the drive hub and the driven hub.

20. The electronic lock device of claim 19, wherein the flexible coupling is axially aligned with the leadscrew and the electric motor along the longitudinal axis.
